(19) United States
(12) Patent Application Publication
(10) Pub. No.: US 2026/0024877 A1
(43) Pub. Date: Jan. 22, 2026

(54) CERAMIC-MODIFIED, ACID-SCAVENGING POLYOLEFIN SEPARATORS

(71) Applicant: AMTEK RESEARCH INTERNATIONAL LLC, Lebanon, OR (US)

(72) Inventors: Weston J. Wood, Lebanon, OR (US); Richard W. Pekala, Corvallis, OR (US)

(21) Appl. No.: 18/998,250

(22) PCT Filed: Aug. 1, 2023
(86) PCT No.: PCT/US2023/071442

§ 371 Date: Jan. 24, 2025

Related U.S. Application Data
(60) Provisional application No. 63/370,214, filed on Aug. 2, 2022.

(51) Int. Cl. H01M 50/451; H01M 50/417; H01M 50/431; H01M 50/434; H01M 50/443; H01M 50/446; H01M 50/457; H01M 50/489

(52) U.S. Cl. CPC H01M 50/451; H01M 50/417; H01M 50/431; H01M 50/434; H01M 50/443; H01M 50/446; H01M 50/457; H01M 50/489

(57) ABSTRACT

The present disclosure relates to the formation of a freestanding. microporous polyolefin membrane that exhibits both high temperature dimensional stability and acid-scavenging capability. Such membranes can include hydrotalcite particles that can contribute to high temperature dimensional stability and acid scavenging. Such membranes can be used to improve the manufacturability, performance (e.g., cycle life), and safety of energy storage devices such as lithium-ion batteries.

### RELATED APPLICATIONS

This application claims priority to U.S. Provisional Patent Application No. 63/370,214, filed on Aug. 2, 2022, and titled CERAMIC-MODIFIED, ACID-SCAVENGING POLYOLEFIN SEPARATORS, which is incorporated herein by reference in its entirety.

### COPYRIGHT NOTICE

© 2023 Amtek Research International LLC. A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR § 1.71 (d).

### TECHNICAL FIELD

The present disclosure relates to the formation of a freestanding, microporous polyolefin membrane that is modified within its bulk structure or on at least one surface with a mixture of inorganic particles, such that the inorganic particles provide both high temperature dimensional stability and acid-scavenging capability. These membranes exhibit (1) in-plane high temperature dimensional stability (i.e., low shrinkage (e.g., less than 10% shrinkage)) at temperatures both above and below the melting point of the polymer matrix of the polyolefin membrane, and (2) exhibit the ability to scavenge acids through an anion exchange mechanism. At high temperatures (>135° C.), the pores within the bulk structure can begin to collapse or shut down, thereby modifying the permeability through the membrane with little change to the in-plane dimensions. Such membranes can be used to improve the manufacturability, performance (e.g., cycle life), and safety of energy storage devices such as lithium-ion batteries.

### BACKGROUND

Separators are an integral part of the performance, safety, and cost of lithium-ion and rechargeable Li metal batteries. During normal operation, the principal functions of the separator are to prevent electronic conduction (i.e., shorts or direct contact) between the anode and cathode while permitting ionic conduction via the electrolyte. For small commercial cells under abuse conditions, such as external short circuit or overcharge, the separator is required to shutdown at temperatures well below where thermal runaway can occur. Shutdown results from the collapse of pores in the separator due to melting and viscous flow of the polymer, thus slowing down or stopping ion flow between the electrodes. Nearly all Li-ion battery separators contain polyethylene as part of a single- or multi-layer construction so that shutdown begins at about 130° C., near the melting point of polyethylene.

Separators for the lithium-ion market are presently manufactured via “dry” or “wet” processes. Celgard LLC and others have described a dry process in which polypropylene (PP) or polyethylene (PE) is extruded into a thin sheet and subjected to rapid drawdown. The sheet is then annealed at 10-25° C. below the polymer melting point such that crystallite size and orientation are controlled. Next, the sheet is rapidly stretched in the machine direction (MD) to achieve slit-like pores or voids. Trilayer PP/PE/PP separators have anisotropic mechanical properties and are difficult to manufacture in high yield at thicknesses of ≤14 um, thereby limiting the volumetric energy density of a lithium-ion cell.

Wet process separators composed of high molecular weight polyethylene are produced by extrusion of a plasticizer/polymer mixture at elevated temperature, followed by phase separation, biaxial stretching, and extraction of the pore former (i.e., plasticizer). The resultant separators have elliptical or spherical pores with good mechanical properties in both the machine and transverse directions. PE-based separators manufactured this way by Toray, SEMCorp, Shenzhen Senior, W-Scope, Asahi-Kasei, SKIET, and ENTEK have found wide use in Li-ion batteries. Wet process separators can be easily produced in thicknesses ranging from 5-12 um, and they are the preferred choice of OEMs that manufacture Li-ion batteries for electric vehicles.

In the case of large format Li-ion or rechargeable Li metal cells designed for electric vehicle applications, the benefits of separator shutdown have been openly questioned because it is difficult to guarantee a sufficient rate and uniformity of shutdown throughout the complete cell. As such, many companies are focused on modifying the construction of a lithium-ion battery to include (1) a heat-resistant separator or (2) a heat-resistant layer coated on either of the electrodes of a conventional polyolefin separator. These approaches are designed to prevent oxidation of the polyolefin surface in high voltage cells and to minimize in-plane separator shrinkage such that the edges of the current collectors cannot touch each other, thereby mitigating the possibility of a short circuit and thermal runaway.

In U.S. Pat. No. 9,896,555 B2, Pekala et al. demonstrated a freestanding, microporous, ultrahigh molecular weight polyethylene (UHMWPE)-based separator that contained sufficient inorganic filler particles distributed throughout the polymer matrix (bulk structure) to provide low shrinkage while maintaining high porosity at temperatures above the melting point of the polymer matrix (>135° C.). Such freestanding, heat resistant separators have excellent wettability and ultralow impedance, but they may not exhibit shutdown properties because of the high loading level of the inorganic filler.

OEM cell manufacturers ideally want the separator to have (1) high temperature dimensional stability and (2) still exhibit shutdown characteristics. In order to meet this demanding requirement, PE separators are coated with a heat resistant inorganic (ceramic) layer on one or both sides. Boehmite and alumina are the two most common ceramics used in the coating process, and in some cases, poly (vinylidene fluoride-co-hexafluoropropylene) (PVDF-HFP) or an acrylate is blended with the ceramics to promote adhesion to the electrodes. A major advantage of ceramic coated, PE separators is that they can still exhibit shutdown in the thickness direction, while sufficient ceramic coating results in excellent high temperature dimensional stability (<5% in-plane shrinkage) at 180° C. which is about 50° C. above the melting point of polyethylene.

In U.S. Pat. No. 7,638,230 B2, a porous heat resistant layer was coated onto the negative electrode. The heat resistant layer was composed of an inorganic filler and a polymer binder. Inorganic fillers included magnesia, titantia, zirconia, or silica. Polymer binders included polyvinylidene fluoride and a modified rubber mixture containing acrylonitrile units. The heat resistant layer comprised 1-5 parts binder for every 100 parts inorganic filler by weight. Higher binder contents negatively impacted the high rate discharge characteristics of the battery. Furthermore, the thickness of the porous heat-resistant layer had to be limited to 1-10 um to achieve high discharge rates, and it could not be removed as a free-standing film. Freestanding refers to a sheet having sufficient mechanical properties to wind or unwind an unsupported web.

In US Patent Application Publication No. 2008/0292968 A1 and US Patent Application Publication No. 2009/0111025 A1, an organic/inorganic separator is disclosed in which a porous substrate is coated with a mixture of inorganic particles and a polymer binder to form an active layer on at least one surface of the porous substrate. The porous substrate can be either a non-woven fabric, membrane, or a polyolefin-based separator. Inorganic particles are selected from a group consisting of those that exhibit a dielectric constant greater than 5, piezoelectricity, and/or lithium ion conductivity. A variety of polymer binders are described. The composite separator is claimed to show excellent thermal safety, dimensional stability, electrochemical safety, and lithium ion conductivity, compared to uncoated polyolefin-based separators used in Li-ion batteries. In the case of certain polymer binders mixed with the inorganic particles, a high degree of swelling with electrolyte can result in the surface layer, but rapid wetting or swelling is not achieved in the polyolefin substrate.

In the latter approaches, there is an inorganic layer that is applied in a secondary coating operation onto the surface of an electrode or porous substrate to provide heat resistance and prevent internal shorts in a battery. Heretofore, there has been no consideration of having the inorganic particles impart acid-scavenging capabilities to improve the cycle life and performance of lithium-ion batteries. While U.S. Pat. No. 10,050,313 B2 and U.S. Pat. No. 10,741,812 B2 discuss organic chelating agents or nitrogen containing polymers that can be coated onto at least one surface or distributed throughout the bulk structure of a polyolefin separator for acid-scavenging, these approaches do not impart high temperature dimensional stability to the separator.

As such, there is a need to develop a ceramic-modified separator that can provide both high temperature dimensional stability and acid-scavenging capability to improve the safety and performance of lithium-ion or rechargeable Li metal batteries. In this disclosure, we utilize synthetic hydrotalcites as inorganic particles that can simultaneously contribute to high temperature dimensional stability and acid scavenging.

### SUMMARY OF THE DISCLOSURE

An object of the present disclosure is to achieve thin, freestanding, microporous polyolefin membranes with excellent high temperature dimensional stability and acid-scavenging capabilities through the incorporation of inorganic particles distributed throughout the polymer matrix of the bulk structure or as a surface coating. Synthetic hydrotalcites have been identified as inorganic particles that can impart the above characteristics. Such particles can be used either by themselves or in combination with other inorganic or organic particles to produce the desired polyolefin membrane. Such polyolefin membranes can be used to form effective separators for energy storage devices, such as lithium-ion batteries.

As used herein, freestanding can refer to a membrane having sufficient mechanical properties that permit manipulation such as winding and unwinding in membrane form for use in an energy storage device assembly. The terms membrane, film, and sheet can be used interchangeably throughout this patent application to describe products made in accordance with the disclosed embodiments, and the term membrane can be used to encompass webs, films, and sheets.

In a first embodiment of the disclosure, the microporous polyolefin membrane is passed through an aqueous dispersion of hydrotalcite particles containing a small percentage of polymer binder such that an inorganic layer of controlled thickness is deposited onto one or both of the first and second major surfaces. Gravure, micro-gravure, slot-die, dip coating, direct metering, or other approaches can be used to control the thickness of the surface coating. The wetted membrane is subsequently dried, such as with a series of air knives in an oven in which hot air is used to evaporate the solvent. The coated membrane is then wound into master rolls that can be later used to form battery separators.

In a second embodiment of the disclosure, the microporous polyolefin membrane is passed through an aqueous dispersion containing hydrotalcite particles, at least one other type of inorganic particles (e.g., fumed alumina, boehmite, or a mixture thereof), and a small percentage of polymer binder such that an inorganic layer of controlled thickness is deposited onto one or both of the first and second major surfaces. As an example, the inorganic particles in the aqueous dispersion can include about 0.1-12% of hydrotalcite particles and about 88-99.9% of at least one other type of inorganic particles. Gravure, micro-gravure, slot-die, dip coating, direct metering, or other approaches can be used to control the thickness of the surface coating. The wetted membrane is subsequently dried, such as with a series of air knives in an oven in which hot air is used to evaporate the solvent. In this case, the surface layer(s) contain a mixture of inorganic particles that both contribute to high temperature dimensional stability, but only the hydrotalcite has the ability to function as an acid-scavenger through an anion exchange

In a third embodiment of the disclosure, the microporous, freestanding polyolefin membrane is manufactured by combining polyethylene (e.g, VHMWPE—Very High Molecular Weight Polyethylene), hydrotalcite particles (or a mixture of hydrotalcite particles and at least one other type of inorganic particles), and a plasticizer (e.g., mineral oil). For example, a dry blend of polyethylene powder and hydrotalcite particles (or a mixture of hydrotalcite particles and at least one other type of inorganic particles) is combined with the plasticizer and extruded into a homogeneous, cohesive mass having hydrotalcite particles (or a mixture of hydrotalcite particles and at least one other type of inorganic particles) distributed throughout. The mass is processed using blown film, cast film, or calendering methods to give an oil-filled sheet that exits a die and can be further biaxially oriented to reduce its thickness and effect its mechanical properties. In an extraction operation, the oil is removed with a solvent that is subsequently evaporated to produce a microporous, freestanding membrane that contains hydrotalcite particles (or a mixture of hydrotalcite particles and at least one other type of inorganic particles) within and distributed throughout the bulk matrix. As an example, the microporous membrane can comprise from about 0.1 wt % to about 80 wt % of hydrotalcite particles (or mixture of hydrotalcite particles and at least one other type of inorganic particles). Optionally, the hydrotalcite-containing membrane can be subsequently coated with at least one other type of inorganic particles (e.g., fumed alumina, boehmite, or a mixture thereof) at a coat weight that is sufficient to impart good high temperature dimensional stability.

In a fourth embodiment, one of the above manufacturing processes is used to produce a microporous free-standing membrane that contains at least one type of inorganic particles (e.g., fumed alumina, boehmite, or mixtures thereof) in the bulk structure. Optionally, the microporous membrane is subsequently coated with a hydrotalcite-containing surface layer at a coat weight that is sufficient to impart good high temperature stability. The hydrotalcite-containing surface layer can either include only hydrotalcite particles as the inorganic particles, or a mixture of hydrotalcite particles and at least one other type of inorganic particles.

The above microporous, freestanding polyolefin membranes can be wound or stacked in a package to separate the electrodes in an energy storage device, for example, a battery, capacitor, supercapacitor, or fuel cell. Membrane pores can be filled with electrolyte both in the surface layers and throughout the inorganic-modified bulk structure. Such membranes are beneficial to the manufacture of energy storage devices, particularly since they combine good heat resistance, in-plane dimensional stability, acid-scavenging capability, and shutdown characteristics.

Additional objects and advantages of this disclosure will be apparent from the following detailed description of preferred embodiments thereof which proceeds with reference to the accompanying drawings.

### BRIEF DESCRIPTION OF THE DRAWINGS

FIG. 1 depicts a titration curve demonstrating the titration of a hydrotalcite dispersion with concentrated HCl.

FIGS. 2A-2D depict vials demonstrating the effects of hydrotalcite on electrolyte degradation compared to control vials.

### DETAILED DESCRIPTION

The membrane used in this disclosure is comprised of a polyolefin matrix. The types of polyolefin and their molecular weight is generally dependent upon the manufacturing process (e.g., blown film vs cast film). In the blown film process, the polyolefin most preferably used is an ultrahigh molecular weight polyethylene (UHMWPE) having an intrinsic viscosity of at least 10 deciliter/gram, and preferably in the range from 18-22 deciliters/gram. The molecular weight of the UHMWPE generally corresponds to a range of between about 3.1 to about 10 million grams/mol. It may be desirable to blend the UHMWPE with other polyolefins such as HDPE or linear low density polyethylene (LLDPE) in order to impact the shutdown properties of the membrane. In the case of cast film, the polyolefin most preferably used is very high molecular weight, high density polyethylene (VHMW-HDPE) at about 600,000 to about 1.5 million grams/mol.

The plasticizer employed in the present disclosure is a nonevaporative solvent for the polyolefin polymer, and is preferably a liquid at room temperature. The plasticizer has little or no solvating effect on the polymer at room temperature; it performs its solvating action at temperatures at or above the softening temperature of the polymer. For UHMWPE, the solvating temperature would be above about 160° C., and preferably in the range of between about 160° C. and about 220° C. It is preferred to use a processing oil, such as a paraffinic oil, naphthenic oil, aromatic oil, or a mixture of two or more such oils. Examples of suitable processing oils include: oils sold by Shell Oil Company, such as Risella® 430X; and oils sold by Calumet Lubricants, such as Hydrocal™ 800; and oils sold by Nynas Inc., such as Nypar® 330.

The polymer/oil mixture is extruded through a sheet die or annular die, and then it is biaxially-oriented to form a thin, oil-filled sheet. Solvent that is miscible with the oil can be used for the extraction step, provided it has a boiling point that makes it practical for drying and separating the solvent from the plasticizer by distillation. Exemplary solvents include 1,1,2 trichloroethylene, perchloroethylene, 1,2-dichloroethane, 1,1,1-trichloroethane, 1,1,2-trichloroethane, methylene chloride, 1,1,2-trichloro-1,2,2-trifluoroethane, various trans-dichloroethylene azeotropes (e.g., Tergo MCF—MicroCare LLC), isoPar-G, hexane, heptane, and toluene. In some cases, it is desirable to select the processing oil such that any residual oil in the polymer sheet after extraction is electrochemically inactive. The resultant polyolefin membrane after extraction is microporous, having a porosity from about 35-65%. The pore size range is generally from about 10 nanometers to several microns, with an average pore size of less than about 1 micrometer. The thickness of the polyolefin membrane can be in the about 3-25 μm range.

The coating formulation used in this disclosure is composed of inorganic particles dispersed in aqueous mixtures that may contain a small amount of alcohol to improve wetting at the surface of the polyolefin membrane. The inorganic particles are typically charge stabilized and stay suspended in the aqeuous mixture. A polymer dispersion or water-soluble polymer are typically used as a binder for the inorganic particles. It is desirable to choose a polymer with hydrogen bonding sites in order to minimize the binder concentration, yet achieve a robust, microporous surface layer that does not easily shed inorganic particles. Acrylates, polyvinyl pyrrolidone, polyvinyl alcohol, carboxy methyl cellulose, and their copolymers or derivatives are representative of preferred polymer binders such that less than or equal to 10 parts polymer binder can be used with 90 parts or more of the inorganic particles.

In the case of Li-ion or rechargeable Li metal batteries, the electrolyte is typically composed of 1-1.2 M LiPF₆ (lithium hexafluorophosphate) dissolved in a mixture of organic carbonates (e.g., dimethyl carbonate (DMC), ethyl-methyl carbonate (EMC)). This lithium salt is highly reactive with water such that hydrofluoric acid (HF) can be easily generated within the electrochemical cell. The presence of hydrofluoric acid accelerates other parasitic reactions (e.g., transition metal dissolution from the cathode active material) that negatively impact the cycle life and performance of a Li-ion battery. While fumed alumina, boehmite, and other inorganic oxides can often adsorb hydrofluoric acid to their surfaces, they are not capable of the ion-exchange mechanism that locks halogen anions within the interlayer region of hydrotalcites.

Hydrotalcites have a layered structure composed of magnesium oxide and aluminum oxide. They are considered layered double hydroxides, an unusual class of layered materials with positively charged hydroxide layers and charge balancing, mobile anions located in the interlayer region. These hydrotalcites can serve as acid scavengers.

While hydrotalcites are anionic clays that can be found in nature, they are available in high purity synthetic form from companies such as Kisuma Americas, Inc (Houston, TX). These high purity, synthetic hydrotalcites can be of most interest for Li-ion batteries as outlined in the examples below.

As set forth above, in some embodiments at least one other type of inorganic particles can be used in addition to the hydrotalcites. Exemplary inorganic particles can include, but are not limited to, inorganic oxides, carbonates, or hydroxides, such as, for example, alumina (e.g., fumed alumina), silica, zirconia, titania, mica, boehmite, magnesium hydroxide, calcium carbonate, and mixtures thereof.

As set forth above, the polymer membranes disclosed herein having inorganic particles distributed within the polyolefin matrix, and/or coated on one or both of the first and second major surfaces, can exhibit in-plane high temperature dimensional stability. In some embodiments, the polymer membrane exhibits a shrinkage of less than 10% in each of the machine and transverse directions when exposed to 180° C. for at least 10 minutes. In another embodiment, the polymer membrane exhibits a shrinkage of less than 10% in each of the machine and transverse directions when exposed to a temperature at least 50° C. above the melting point of the polyolefin matrix (or a polyolefin in the polyolefin matrix) for at least 10 minutes. In some of such embodiments, the coating weight is less than 6 g/m².

### Example 1

A 9 μm thick, microporous ultrahigh molecular weight polyethylene-containing separator, ENTEK EPX (ENTEK Membranes LLC, Oregon) was coated with an aqueous-based dispersion that contained the following:

| 52.9 | g | Selvol 09-325 (aqueous based |
|---|---|---|
| | | polyvinyl alcohol hydrolyzed; |
| | | solution; 98% 8.5 wt % solids; Sekisui) |
| 281.6 | g | Deionized water |
| 20 | g | Isopropanol |
| 2 | g | BYK 154 dispersant |
| 145.5 | g | Hydrotalcite (DHT-4C, Kisuma) |

The coating dispersion contained 30 wt % solids with 97/3 Hydrotalcite/polyvinyl alcohol (PVOH) mass ratio. The separator was dip-coated through a bath containing the aqueous-based dispersion, and the thickness of the wet layer was controlled on each side with #7 Mayer rods. The wetted separator was then dried with a series of air knives and transported through a vertical oven at 80° C. and wound on a core, prior to testing. Table I shows physical properties of the prepared coated separator in Example 1.

TABLE I

| | Total | Coating Only | Coat | 180° C. MD | 180° C. TD | |
|---|---|---|---|---|---|---|
| | Thickness | Thickness | Weight | Shrinkage | Shrinkage | Gurley |
| Name | (μm) | (μm) | (g/m²) | (%) | (%) | (sec/100 cc) |
| Ex. 1 | 15.1 | 6.1 | 5.1 | 9.4 | 6.6 | 60 |

### Example 2

A naphthenic process oil (140 kg) was dispensed into a Ross mixer, where the process oil was stirred and degassed. Next, the following were added and mixed with the oil:

| | | |
|---|---|---|
| 64 | kg | UHMWPE (Molecular weight about 5 million g/mol) |
| 32 | kg | VHMWPE (Molecular weight about 1.2 million g/mol) |
| 32 | kg | HMW-HDPE (Molecular weight about 0.6 million g/mol) |
| 1.2 | kg | Li Stearate |
| 1.2 | kg | Antioxidant |

The mixture was blended at about 40° C. until a uniform 47 w/w % polymer slurry was formed. The polymer slurry was then pumped into a 103-mm diameter, co-rotating twin screw extruder, while a melt temperature of about 215° C. was maintained. Simultaneously, a second loss-in-weight feeder was used to add hydrotalcite DHT-4V powder (Kisuma Americas, Inc; Houston, TX) at 5 kg/hr. The extrudate passed through a melt pump that fed a 257-mm diameter annular die having a 2.75 mm gap. The throughput through the die was 235 kg/hr, and the extrudate was inflated with air to produce a biaxially oriented, oil-filled film with about 2250 mm diameter, which inflated extrudate was then passed through an upper nip at 20 m/min to collapse the bubble and form a double layer, which was subsequently side-slit into two individual layers.

The oil-filled layers were then extracted in-line with trichloroethylene (TCE), followed by subsequent evaporation of the TCE in a hot air oven that was attached to a series of carbon beds for vapor recovery. The extracted sheet was further stretched in the machine direction (50° C.) and transverse direction (128° C.) to achieve a 9 um thick separator that was would into master rolls.

The hydrotalcite loading level in the separator was determined to be approximately 4.4 wt % as determined by thermogravimetric analysis.

Example 3

The following powders were dry blended:

| | | |
|---|---|---|
| 511 | g | HMW-HDPE (Molecular weight about 0.6 million g/mol) |
| 256 | g | Fumed alumina (Spectral 81) |
| 33 | g | Hydrotalcite DHT-4A-2 (Kisuma Americas Inc) |

The mixed powders and 100 g of process oil (Hydrocal 800) were then combined and fed to a 27 mm twin screw extruder. Additional oil was added at the throat of the extruder. The mixture was extruded at elevated temperature (about 160° C.) through a sheet die into a horizontal calender roll stack. The extruded sheet was approximately 560 um thick. The oil-filled sheet was subsequently stretched 9×9 at 115 C in a Karo-5 lab unit (Bruckner; Germany). The stretched sheets were then mounted in frame and extracted with Tergo MCF solvent. The solvent-laden sheet was retained in the frame and placed in an oven where the solvent was dried at 80° C. The resultant microporous membrane had a thickness of 11.9 um, puncture strength of 294 grams-force, and a Gurley value of 89 (sec/100 cc air).

### Example 4

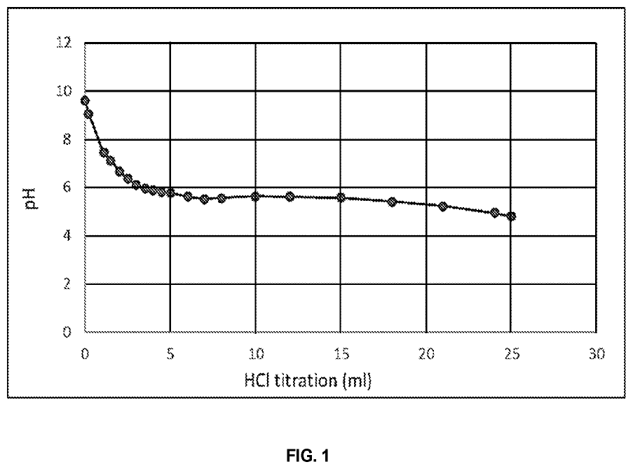

The following example describes a method for titrating hydrotalcite with concentrated HCl. 20 g of hydrotalcite (DHT-4C, Kisuma) was dispersed in 180 g of deionized water. The dispersion was agitated with a magnetic stir bar throughout the titration. Concentrated HCl (37% HCl, ACS Grade, VWR Analytical BHD) was added to a 25 ml burette and used as the titrant. A Milwaukee MW102 pH meter was used to measure the pH during the titration. Initially, concentrated HCl was added in 0.5 ml increments using the 25 ml burette. Measurements were recorded after the Milwaukee meter indicated that pH was stabilized. The HCl titration curve is shown in FIG. 1. These results demonstrate that hydrotalcite has an excellent ability to function as an acid scavenger.

### Example 5

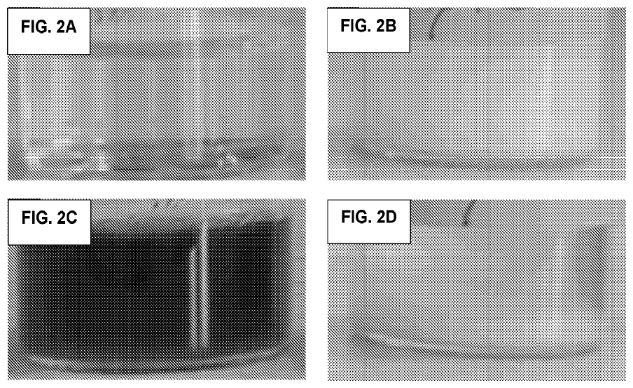

The impact of hydrotalcite on lithium-ion electrolyte aging was evaluated as follows. Hydrotalcite (0.54 g, DHT-4C, Kisuma) was added to a 20 ml scintillation vial (borosilicate glass, melamine lid, PTFE seal). The scintillation vial containing hydrotalcite and a control 20 ml scintillation vial (without hydrotalcite) was dried at 120° C. for 48 hours. After drying, scintillation vials were transferred to a glove box, and 5 ml of 1M LiPF₆ in 1:1 ethylene carbonate:ethyl methyl carbonate (EC:EMC) electrolyte (Aldrich) was added to each of the scintillation vials. The scintillation vials were then sealed and placed in an oven at 60° C. for 144 hrs. FIGS. 2A-2D show 60° C. aging results, with FIG. 2A depicting the control vial at 0 hrs; FIG. 2B depicting the hydrotalcite vial at 0 hrs; FIG. 2C depicting the control vial at 144 hrs; and FIG. 2D depicting the hydrotalcite vial at 144 hrs. As demonstrated, the control vial containing only electrolyte showed substantial darkening of the electrolyte (FIG. 2C). In contrast, electrolyte containing hydrotalcite showed minimal discoloration (FIG. 2D). These results indicate that hydrotalcite effectively acted to minimize electrolyte degradation.

### Example 6

A 9 μm thick, microporous ultrahigh molecular weight polyethylene-containing separator, ENTEK EPX (ENTEK Membranes LLC, Oregon) was coated with an aqueous-based dispersion that contained the following:

| 362 | g | Deionized water |
|---|---|---|
| 20 | g | Isopropanol |
| 22.5 | g | Soteras V (polyvinyl pyrrolidone-based |
| | | aqueous solution; 20 wt % solids; Ashland) |
| 0.5 | g | Soteras B (crosslinker, Ashland) |
| 45 | g | Boehmite (AOH 70, Nabaltec) |
| 50 | g | Hydrotalcite (DHT-4C, Kisuma) |

The coating dispersion was composed of 20 wt % solids with 45/50/5 Boehmite/hydrotalcite/binder mass ratio. The separator was dip-coated through a bath containing the aqueous-based dispersion, and the thickness of the wet layer was controlled on each side with #10 Mayer rods. The wetted separator was then dried with a series of air knives and transported through a vertical oven at 80° C. and wound on a core, prior to testing. Table 2 shows physical properties of the prepared coated separator in Example 6.

TABLE 2

| | Emveco | Coating | Coat | 180° C. MD | 180° C. TD | |
|---|---|---|---|---|---|---|
| | Thickness | Thickness | Weight | Shrinkage | Shrinkage | Gurley |
| Name | (μm) | (μm) | (g/m²) | (%) | (%) | (sec/100 cc) |
| Ex. 6 | 14 | 5 | 5.6 | 5.4 | 5.1 | 70 |

### Example 7

A 9 μm thick, microporous ultrahigh molecular weight polyethylene-containing separator, ENTEK EPX (ENTEK Membranes LLC, Oregon) was coated with an aqueous-based dispersion that contained the following:

| 362 | g | Deionized water |
|---|---|---|
| 20 | g | Isopropanol |
| 22.5 | g | Soteras V (polyvinyl pyrrolidone-based |
| | | aqueous solution; 20 wt % solids, Ashland) |
| 0.5 | g | Soteras B (Crosslinker; Ashland) |
| 85 | g | Boehmite (AOH 70, Nabaltec) |
| 10 | g | Hydrotalcite (DHT-4C, Kisuma) |

The coating dispersion was composed of 20 wt % solids with 85/10/5 Boehmite/hydrotalcite/binder mass ratio. The separator was dip-coated through a bath containing the aqueous-based dispersion, and the thickness of the wet layer was controlled on each side with #11 Mayer rods. The wetted separator was then dried with a series of air knives and transported through a vertical oven at 80° C. and wound on a core, prior to testing. Table 3 shows physical properties of the prepared coated separator in Example 7.

TABLE 3

| | Emveco | Coating | Coat | 180° C. MD | 180° C. TD | |
|---|---|---|---|---|---|---|
| | Thickness | Thickness | Weight | Shrinkage | Shrinkage | Gurley |
| Name | (μm) | (μm) | (g/m²) | (%) | (%) | (sec/100 cc) |
| Ex. 7 | 12.5 | 3.5 | 5.9 | 2.5 | 2.6 | 78 |

It will be apparent to those having skill in the art that many changes may be made to the details of the above-described embodiments without departing from the underlying principles of the disclosure. The scope of the present disclosure should, therefore, be determined only by the following claims.

1. A freestanding, microporous polymer membrane for use in an energy storage device, the freestanding, microporous polymer membrane comprising:
a polyolefin matrix having first and second major surfaces, inorganic particles distributed within the polyolefin matrix and/or coated on one or both of the first and second major surfaces, wherein the inorganic particles comprise acid scavengers.

2. The freestanding, microporous polymer membrane of claim 1, wherein the freestanding, microporous polymer membrane exhibits in-plane high temperature dimensional stability.

3. The freestanding, microporous polymer membrane of claim 1, wherein the inorganic particles comprise hydrotalcite.

4. The freestanding, microporous polymer membrane of claim 3, wherein the inorganic particles comprise synthetic hydrotalcite.

5. The freestanding, microporous polymer membrane of claim 1, wherein the inorganic particles comprise a mixture of hydrotalcite and at least one other type of inorganic particles.

6. The freestanding, microporous polymer membrane of claim 5, wherein the inorganic particles comprise a mixture of about 0.1-12% of hydrotalcite and about 88-99.9% of at least one other type of inorganic particles.

7. The freestanding, microporous polymer membrane of claim 5, wherein the at least one other type of inorganic particles comprises inorganic oxides, carbonates, or hydroxides.

8. The freestanding, microporous polymer membrane of claim 1, wherein the inorganic particles are distributed throughout the polyolefin matrix.

9. The freestanding, microporous polymer membrane of claim 1, wherein the inorganic particles are coated on one or both of the first and second major surfaces.

10. The freestanding, microporous polymer membrane of claim 1, wherein the freestanding, microporous polymer membrane exhibits a shrinkage of less than 10% in each of the machine and transverse directions when exposed to 180° C. for at least 10 minutes.

11. The freestanding, microporous polymer membrane of claim 1, wherein the inorganic particles are coated on one or both of the first and second major surface, and wherein the coating weight is less than 6g/m².

12. The freestanding, microporous polymer membrane of claim 1, wherein the freestanding, microporous polymer membrane exhibits a shrinkage of less than 10% in each of the machine and transverse directions when exposed to a temperature at least 50° C. above the melting point of a polyolefin in the polyolefin matrix for at least 10 minutes.

13. The freestanding, microporous polymer membrane of claim 1, wherein inorganic particles comprising hydrotalcite are distributed throughout the polyolefin matrix, and wherein at least one other type of inorganic particles is coated on one or both of the first and second major surfaces.

14. The freestanding, microporous polymer membrane of claim 13, wherein the at least one other type of inorganic particles comprises inorganic oxides, carbonates, or hydroxides.

15. An energy storage device comprising the freestanding, microporous polymer membrane of any one of claim 1.

16. A freestanding, microporous polymer membrane for use in an energy storage device, the freestanding, microporous polymer membrane comprising:
a polyolefin matrix having first and second major surfaces;
a coating disposed on one or both of the first and second major surfaces, wherein the coating comprises inorganic particles; and
an acid scavenger distributed in at least one of the polyolefin matrix or the coating,
wherein the freestanding, microporous polymer membrane exhibits in-plane high temperature dimensional stability, and wherein the coating weight is less than 6 g/m².

17. The freestanding, microporous polymer membrane of claim 16, wherein the acid scavenger comprises hydrotalcite.

18. (canceled)

19. The freestanding, microporous polymer membrane of claim 16, wherein the inorganic particles comprises inorganic oxides, carbonates, or hydroxides.

20. The freestanding, microporous polymer membrane of claim 16, wherein the freestanding, microporous polymer membrane exhibits a shrinkage of less than 10% in each of the machine and transverse directions when exposed to 180° C. for at least 10 minutes.

21. The freestanding, microporous polymer membrane of claim 16, wherein the freestanding, microporous polymer membrane exhibits a shrinkage of less than 10% in each of the machine and transverse directions when exposed to a temperature at least 50° C. above the melting point of a polyolefin in the polyolefin matrix for at least 10 minutes.

22-23. (canceled)
